(19) United States
(12) Patent Application Publication
(10) Pub. No.: US 2005/0128760 A1
(43) Pub. Date: Jun. 16, 2005

(54) Electroluminescent light arrangement

(75) Inventor: Helmut Moser, Bruchsal (DE)

Correspondence Address: SUGHRUE MION, PLLC, 2100 PENNSYLVANIA AVENUE, N.W., SUITE 800, WASHINGTON, DC, 20037, US

(73) Assignee: FER Fahrzeugelektrik GmbH

(21) Appl. No.: 10/954,339

(22) Filed: Oct. 1, 2004

(30) Foreign Application Priority Data
Oct. 2, 2003 (DE) 203 15 251.4

(51) Int. Cl. B60Q 1/00; B60Q 1/26

(52) U.S. Cl. 362/488

(57) ABSTRACT

In an electroluminescent light arrangement (5), in particular for the internal fitment of vehicles, which includes at least one flat capacitor (6) with a flat areal base electrode (8), a pigment layer (12) applied to at least one flat side of the base electrode (8) and a transparent, electrically conducting cover electrode (14) which covers the pigment layer (12) and through which in operation issues the light emitted by the pigment layer (12), to expand the options in relation to design configuration, it is provided that at least a part of the lighting surface of the flat capacitor (6) is covered by a flock layer (16, 18) which includes short fibers (18) and which is at least partly transparent in relation to the light of the pigment layer (12).

The invention concerns an electroluminescent light arrangement of the kind set forth in the classifying portion of claim 1.

Such lights arrangements are increasingly used wherever flat areal lights of uniform brightness and involving an extremely small structural depth are required. That also applies, without being restricted thereto, to the passenger compartments of vehicles, in particular motor vehicles, in which parts of the interior lining, for example the roof or side pillars, are in the form of space lights or recesses such as for example glove boxes into which only little light is incident from the exterior are provided with an additional light.

In that respect it is desirable not only to use a simple homogeneously lighting surface or recess lining, but in addition also to afford possible options in terms of decorative configuration.

In this connection attention is to be directed to German utility model No 202 15 764.4 in which an electroluminescent light arrangement of the kind set forth in the classifying portion of claim 1 is combined with a pattern of holes in a grid configuration in order to provide partial transparency for extraneous or external light.

In comparison therewith the object of the present invention is to so design an electroluminescent light arrangement of the kind set forth in the opening part of this specification that further design configuration options are afforded.

To attain that object the invention provides the features set forth in claim 1.

By virtue of the fact that a flocking layer which comprises an adhesive layer and short fibers which are anchored therein with one of their ends but which otherwise are freely projecting and which is at least partially transparent for the light emitted by the pigment layer of the flat capacitor is applied over the lighting surface of the flat capacitor, that is to say either directly on its transparent, electrically conducting cover electrode or on a protective layer covering that cover electrode, the electroluminescent light arrangement according to the invention has a suede-like or velvet-like appearance and has a textile-like feel when touched with the human hand.

Particularly when the internal lining components of the passenger compartment of a vehicle are covered with textile materials an electroluminescent light arrangement according to the invention blends extremely harmoniously into such an assembly because, in the switched-off condition, the light character thereof is fully in the background and presents a viewer with the same textile-like surface as the non-lighting regions which surround it.

An electroluminescent light arrangement according to the invention is also particularly suitable especially as a lining of recesses which serve to store articles and which require additional lighting such as for example glove boxes or accommodation dishes and pockets in the center console or the doors of vehicles because the electroluminescent light arrangement of the invention on the one hand affords a very uniform light and on the other hand it provides a pleasant contact with the skin when a user comes into contact with the light with his hand when feeling in such a container.

As an electroluminescent light arrangement according to the invention is of an extremely small structural depth and can be produced from flexible or deep-drawable materials, it can be adapted to virtually any three-dimensional shapes.

Both the adhesive layer and also the short fibers embedded with their one ends in the adhesive layer can be produced from the most varying materials which either as such are completely transparent for the light emitted by the respective flat capacitor or which have at least a high degree of transparency.

It should be expressly pointed out that an electroluminescent light arrangement according to the invention is suitable not only for situations of use in the vehicle sector but also in the residential sector, in advertising and many other sectors in which the specific properties thereof are desired.

Advantageous developments and configurations of an electroluminescent light arrangement are set forth in the appendant claims.

The electrically conducting cover electrode of the flat capacitor or a protective layer covering same is flocked in such a way that firstly a special fiber adhesive is applied, into which the flock fibers are electrically fired while still in the wet condition. In that respect it is possible in principle to use any textile fiber. The most usual fibers comprise polyamide, viscose or polyester. The density and length of the fibers can be varied from one situation of use to another, whereby the feel of the surface can be varied from soft velvet to brush-like.

The operation of firing the fibers into the adhesive can be effected by means of an electrostatic flocking apparatus. That apparatus charges the short fibers to a voltage of between 50 and 90 kV. As a result they jump from the flocking apparatus along the electrostatic field lines to any earthed surface.

In this connection there is particular advantage in the fact that the cover electrode of the flat capacitor is electrically conducting and can thus be grounded in a simple fashion, which is an important prerequisite for good and uniform flocking.

To produce the flocking effect the flocking apparatus can be moved with a slight shaking action over the surface to be flocked. As a result, the first fibers are first fired into the adhesive at a spacing of about 10 cm, and they stabilise the adhesive layer. After some seconds the spacing relative to the surface to be flocked is then progressively reduced in order to fill that surface as densely as possible.

Special electrically conductive adhesives are used as the adhesives. They have to enjoy good adhesion not only to the substrate but also to the fibers. Depending on the respective situation of use they must also meet further requirements, for example resistance to washing, resistance to oil and so forth.

After the flock fibers have been applied the flocked surface is cleaned of loose fibers by sucking them away, blowing them away, knocking them off, brushing them off, washing them off or the like.

The invention is described hereinafter by means of an embodiment by way of example with reference to the drawing in which:

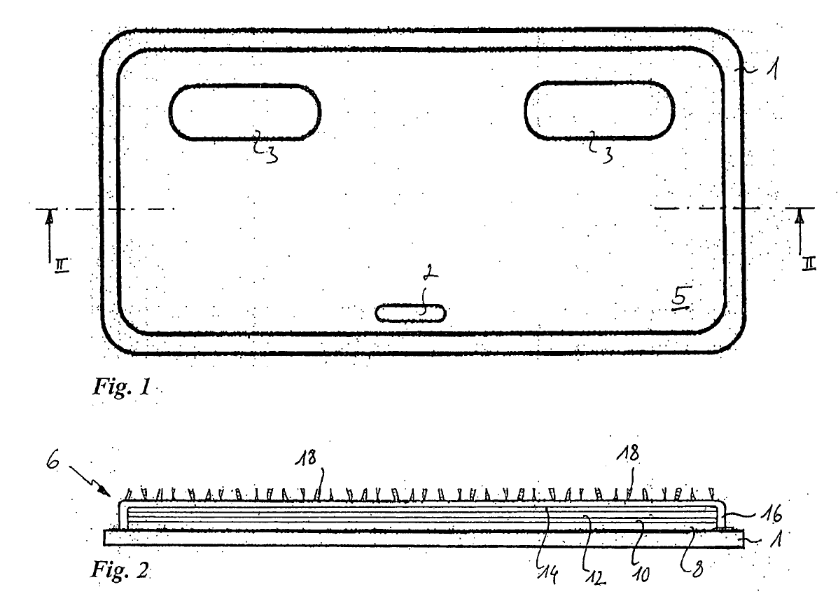

FIG. 1 is a highly diagrammatic plan view of the underside of a displaceable sunroof panel shade for a motor vehicle which carries an electroluminescent light arrangement according to the invention, and

FIG. 2 shows a view in section through the sunroof panel shade of FIG. 1 taken along line II-II.

The displaceable sunroof panel shade 1 shown in the Figures is intended to be arranged in the interior of a motor vehicle under the glass roof thereof in such a way that it can be pulled across in front of the glass roof or pushed back, depending on the respective need involved. On its underside shown in FIG. 1 the sunroof panel shade 1 has a gripping recess 2 and two vent openings 3. With the exception of those elements almost its entire underside is covered with an electroluminescent light arrangement 5 according to the invention.

As shown in FIG. 2 the electroluminescent light arrangement 5 comprises a single flat capacitor 6 which in conventional manner includes an electrically conducting base electrode 8, an insulating layer 10 which completely covers over the base electrode 8, a pigment layer 12 arranged over the insulating layer 10 and an extremely thin cover electrode 14 which is transparent in relation to the light which in operation of the flat capacitor 6 is emitted by the pigment layer 12.

It should be expressly pointed out here that the thicknesses of the individual layers are shown on a greatly enlarged scale in FIG. 2 for the sake of clarity of the drawing and are also not reproduced true to scale in relation to each other.

In order to produce the above-mentioned lighting of the pigment layer 12, an ac voltage of suitable frequency and amplitude is applied to the two electrodes 8 and 14 in known manner by way of line connections (not shown).

In accordance with the invention the top side of the flat capacitor 6, which emits the light, is covered over by a dried or hardened adhesive layer 16 in which a plurality of short fibers 18 were embedded in manufacture in such a way that they are fixedly anchored with their one end in the dried or hardened adhesive layer 16, but project freely and almost perpendicularly above the surface of the adhesive layer 16 with the large part of the fiber length. The intermediate spaces between the fibers 18 which are shown on an excessively large scale in FIG. 2 are so selected that, in operation of the flat capacitor 6, they allow the light emitted by its pigment layer 12 to pass therethrough. The fibers 18 can also comprise a material which is transparent as such for that light. In that case the individual fibers 18 can then be arranged in very closely mutually juxtaposed relationship.

In the illustrated embodiment the adhesive layer 16 covers over not only the surface of the flat capacitor 6 but also the side edges thereof and comprises a material which is impermeable to water in the dried or hardened condition so that at the same time it protects the flat capacitor 6 against the ingress of moisture. As an alternative thereto it is also possible to provide an additional protective layer between the transparent cover electrode 14 and the adhesive layer 16.

The described flocking imparts to the underside of the sunroof panel shade 1 a suede-like or velvet-like nature which is visually attractive and which when touched gives a pleasant feel. At the same time the sunroof panel shade 1 can serve as a flat areal light source for the interior of the motor vehicle in question.

Both the adhesive layer 16 and also the fibers 18 of the flocking can be colorless so that the color of the light emitted by the electroluminescent light arrangement 5 according to the invention depends solely and simply on the properties of the flat capacitor 6 and in particular the color of the pigments in the pigment layer 12 but also the frequency and amplitude of the applied ac voltage.

As an alternative thereto it is possible for the adhesive layer 16 and/or the fibers 18 to be provided with a color which differs from the color of the light emitted by the pigment layer 12, whereby it is possible to achieve attractive mixed color effects. It is also possible for the adhesive layer 16 and/or the fibers 18 to be colored differently in different regions of the surfaces thereof.

It is also possible for a plurality of flat capacitors to be arranged in mutually juxtaposed relationship on the surface of the sunroof panel shade 1 shown in FIG. 1, which capacitors for example have a common base electrode 8 but cover electrodes 14 which are electrically separated from each other, so that they can be actuated and caused to light up independently of each other.

1-17. (canceled)

18. An electroluminescent light arrangement including
at least one flat capacitor which comprises at least the layers including a flat areal base electrode having at least one flat side, a pigment layer applied to the at least one flat side of the base electrode, and a transparent, electrically conducting cover electrode which covers the pigment layer and through which in operation issues light emitted by the pigment layer, and
a flock layer which includes short fibers and covering at least a part of the lighting surface of the flat capacitor and being at least partly transparent in relation to the light of the pigment layer.

19. An electroluminescent light arrangement as set forth in claim 18, wherein the flat capacitor includes between the base electrode and the pigment layer an insulating layer which increases its dielectric strength.

20. An electroluminescent light arrangement as set forth in claim 18, including between the transparent cover electrode and the flock layer a protective layer which is transparent in relation to the light of the pigment layer and operable to protect the flat capacitor from the ingress of moisture.

21. An electroluminescent light arrangement as set forth in claim 18, wherein the flock layer includes an adhesive layer which is transparent in relation to the light of the pigment layer and into which each of the short fibers is embedded with one of their ends.

22. An electroluminescent light arrangement as set forth in claim 21, wherein the transparent adhesive layer serves at the same time as a protective layer.

23. An electroluminescent light arrangement as set forth in claim 21, wherein the transparent adhesive layer is colored in a color which is different from the color of the light emitted by the pigment layer so that in operation a mixed color is produced.

24. An electroluminescent light arrangement as set forth in claim 21, wherein the transparent adhesive layer is formed by a single-component system.

25. An electroluminescent light arrangement as set forth in claim 24, wherein the transparent adhesive layer is formed by an acrylate-base water-soluble dispersion adhesive.

26. An electroluminescent light arrangement as set forth in claim 24, wherein the transparent adhesive layer is formed by a quick-drying water-soluble dispersion adhesive.

27. An electroluminescent light arrangement as set forth claim 21, wherein the transparent adhesive layer is formed by a two-component system.

28. An electroluminescent light arrangement as set forth in claim 27, wherein the transparent adhesive layer is formed by a solvent-bearing polyurethane adhesive mixed with a hardener.

29. An electroluminescent light arrangement as set forth in claim 18, wherein the short fibers are of a color which is different from the color of the light emitted by the pigment layer so that in operation a mixed color is produced.

30. An electroluminescent light arrangement as set forth in claim 18, wherein the length of the short fibers is in a range of between 0.1 mm and 2 mm.

31. An electroluminescent light arrangement as set forth in claim 18, wherein the short fibers at least partly comprise polyamide.

32. An electroluminescent light arrangement as set forth in claim 18, wherein the short fibers at least partly comprise viscose.

33. An electroluminescent light arrangement as set forth in claim 18, wherein the short fibers at least partly comprise cotton.

34. An electroluminescent light arrangement as set forth in claim 18, wherein the short fibers at least partly comprise polyester.
